(19) United States
(12) Patent Application Publication
(10) Pub. No.: US 2003/0145068 A1
(43) Pub. Date: Jul. 31, 2003

(54) Appliance server configuration recovery for a highly optimized server configuration profile image

(76) Inventor: Enrique Guillen, Houston, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/061,871

(22) Filed: Jan. 31, 2002

(51) Int. Cl. G06F 15/177

(52) U.S. Cl. 709/220

(57) ABSTRACT

A server includes a non-volatile random access memory (NVRAM), mechanical switches and a read only memory (ROM). The ROM includes code containing highly optimized server configuration profile images, code to detect a predetermined state of the NVRAM, code to reboot the server in response to detecting the predetermined state of the NVRAM, code to read state information from the mechanical switches following the reboot and code to write a highly optimized server configuration profile image to the NVRAM based on the state information. Using a utility, the server can be dynamically configured with a highly optimized server configuration profile image. The utility includes code to generate the profile image based on a current configuration of the server, code to store the profile image in the NVRAM, code to parse the profile image and code to write the profile image to the ROM.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to configuration of servers and more particularly to server configuration recovery for a highly optimized server configuration profile image.

2. Description of the Related Art

To improve data storage management capabilities, many servers today are being optimized or tuned for specialized server environments. These types of servers are commonly termed “appliance servers.” One type of appliance server is a web server such as the TaskSmart W-Series servers of Compaq Computer Corporation. Web servers are generally optimized for web hosting. Another type of appliance server is a cache server such as Compaq's TaskSmart C-Series servers. Cache servers are generally optimized for content networking and media streaming. A third type of appliance server is a network attached storage (NAS) server such as Compaq's TaskSmart N-Series servers. NAS servers are generally optimized for file serving and storage consolidation. A fourth type of appliance server is a server optimized for accelerated secure transactions. A firewall server would be an example of this fourth appliance server type. Each appliance server type has traditionally required its own separate configuration code and a separate system board.

Servers are typically shipped with minimal hardware rather than all the hardware devices necessary to be optimized or configured for specialized server environments. Each time a hardware device is added to a server, the server is typically halted. A user must then either press F1 or run a configuration utility for the server to continue. Since many servers are deployed without keyboards or monitors, a server typically must be pulled from its rack and connected to a keyboard and monitor in order for someone to restore the server configuration.

Another circumstance when a server is halted or locked up is when the non-volatile random access memory (NVRAM) of the server is corrupted. The NVRAM stores the configuration data that defines the personality of the server. NVRAM, which can be thought of as the RAM for the Basic Input/Output System Code (BIOS) in the server, is sensitive to power loss. If NVRAM becomes corrupted or suffers a data loss, then the server must be manually reconfigured. This reconfiguration typically involves use of a configuration file and software configuration tool to regenerate the configuration data for the server.

### BRIEF SUMMARY OF THE INVENTION

Briefly, a server provides server configuration recovery for a highly optimized server configuration profile image. The server includes a processor, a non-volatile random access memory, a plurality of mechanical switches and a read only memory. The read only memory includes code containing a plurality of highly optimized server configuration profiles, code to detect a predetermined state of the non-volatile random access memory, code to reboot the server in response to detecting the predetermined state of the non-volatile random access memory, code to read state information from the plurality of mechanical switches following the reboot and code to write a highly optimized server configuration profile of the plurality of highly optimized server configuration profiles to the non-volatile random access memory based on the state information.

Using a utility, the server can be dynamically configured with a highly optimized server configuration profile image. The utility includes code to generate the server configuration profile image based on a current configuration of the server, code to store the server configuration profile image in the non-volatile random access memory, code to parse the server configuration profile image and code to write the server configuration profile image to the read only memory.

### BRIEF DESCRIPTION OF THE SEVERAL VIEWS OF THE DRAWINGS

A better understanding of the present invention can be obtained when the following detailed description of some embodiments is considered in conjunction with the following drawings in which:

FIG. 1 is a block diagram of an exemplary high-end network attached storage server appliance;

FIG. 2 is a block diagram of an exemplary high-end cache server appliance;

FIG. 3 is a block diagram of a server circuit board containing a read only memory including multiple server configuration profile images;

FIG. 4 is a flow chart of an exemplary server configuration recovery process in accordance with FIG. 3;

FIG. 5 is a table of exemplary server configuration profile images in relation to the switch settings of FIG. 3;

FIG. 6 is a table of more exemplary server configuration profile images in relation to the switch settings of FIG. 3;

FIG. 7 is a flow chart of an exemplary profile support process to write a highly optimized server configuration profile image to the NVRAM of FIG. 3; and

FIG. 8 is a flow chart of an exemplary utility process to dynamically generate a highly optimized server configuration profile image.

### DETAILED DESCRIPTION OF THE INVENTION

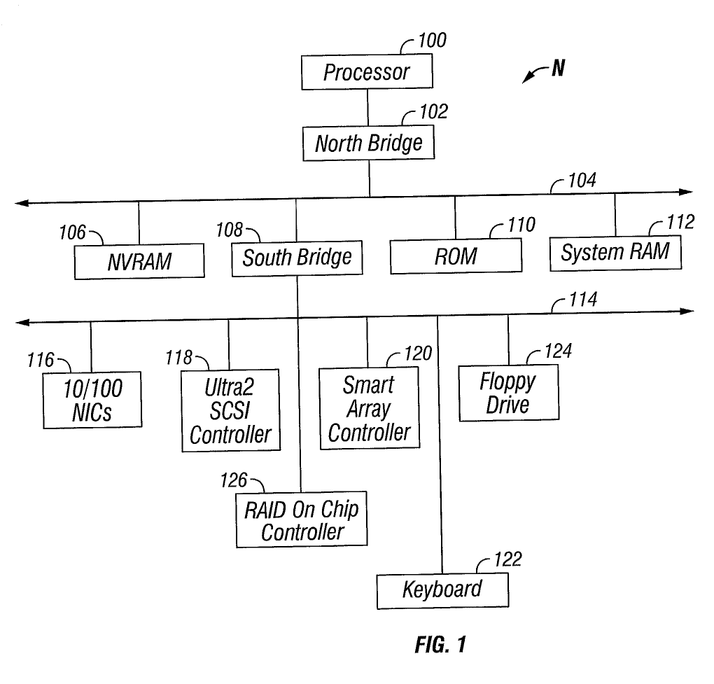

Turning to the drawings, FIG. 1 shows an exemplary hardware architecture for a high-end network attached server (NAS) appliance N. A processor 100 is coupled through a north or host/PCI bridge 102 to a Peripheral Component Interconnect (PCI) bus 104. Coupled to the PCI bus 104 are a non-volatile random access memory (NVRAM) 106, a read only memory (ROM) 110 and a system random access memory (RAM) 112. The ROM 110 may for instance be a 512 KB AMD (Advanced Micro Devices) 29F040B. A south or PCI/PCI bridge 108 bridges the PCI bus 104 to a PCI bus 114. Coupled to the PCI bus 114 are 10/100 Ethernet network interface controllers (NICs) 116, an Ultra2 SCSI (Small Computer System Interface) controller 118, a Smart Array or other storage controller 120, a RAID on chip (ROC) controller 126, a keyboard 122 and a floppy drive 124. The illustrated hardware generally represents an optimized configuration for a NAS server appliance personality. An example of a NAS server appliance is Compaq's N2400. Other NAS server appliances of Compaq are part of Compaq's TaskSmart N-Series servers.

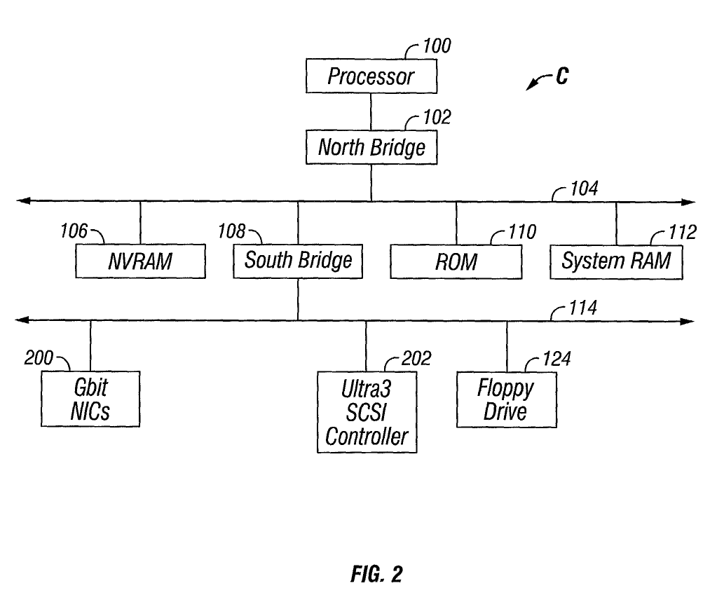

Referring to FIG. 2, an exemplary hardware architecture for a high-end cache server appliance C is shown. The devices upstream of the south bridge 108 are the same as shown in FIG. 1. Downstream of the south bridge 108 are Gigabit (Gbit) NICs 200, Ultra3 SCSI controllers 202 and the floppy drive 124 coupled to the PCI bus 114. The illustrated hardware generally represents an optimized configuration for a cache server appliance personality. While the NAS appliance N of FIG. 1 provides the Ultra2 SCSI controller 118, the cache server appliance C provides the faster Ultra3 SCSI controllers 202. While the NAS appliance N of FIG. 1 provide the 10/100 NICs 116, the cache server appliance C provides the faster Gbit NICs 200. The cache server appliance C thus is optimized to provide faster access to data than the NAS appliance N. While the floppy drive 124 is shown in FIG. 2, the cache server appliance C does not boot from a floppy. An example of a cache server appliance is Compaq's C2500. Other cache server appliances of Compaq are part of Compaq's TaskSmart C-Series servers. Both the N2400 and C2500 are high-end appliance servers with hardware configurations and system resource configurations optimized for performance, reliability, scalability and availability. The N2400 and the C2500 can generally handle up to 2700 transactions per second.

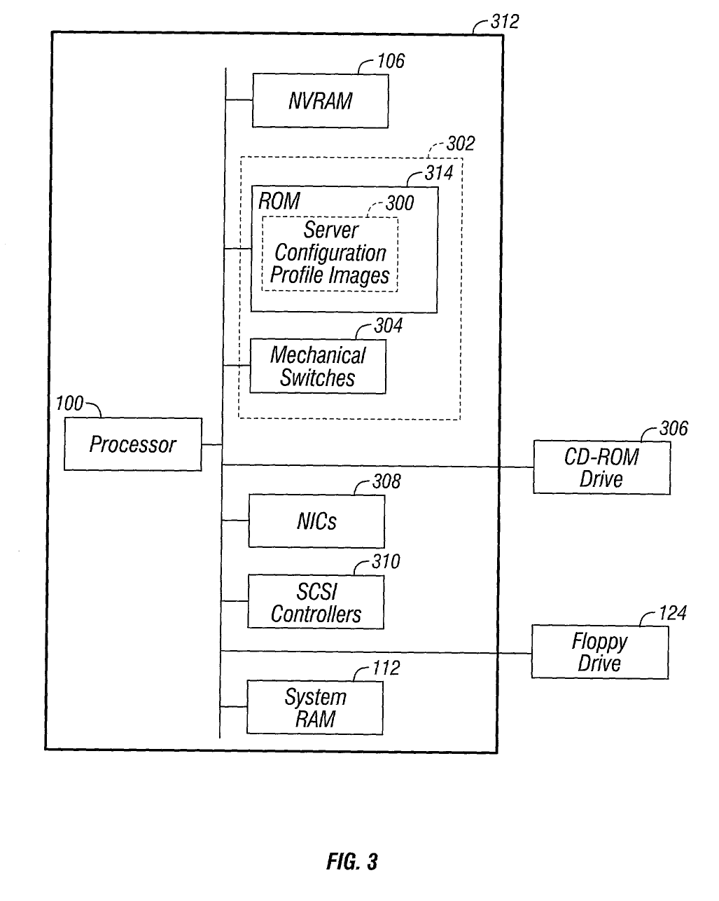

Referring to FIG. 3, an exemplary circuit board for a high-end server is shown. A system board 312 includes the processor 108, the NVRAM 106, and the system RAM 112 previously illustrated in FIGS. 1 and 2. The system board 312 further includes NICs 308 and SCSI controllers 310 coupled to the processor 100. The NICs 308 may represent the 10/100 NICs 116 of FIG. 1, the Gbit NICs 200 of FIG. 2 or a combination thereof. The SCSI controllers 310 may represent the Ultra2 SCSI controller 118 of FIG. 1, the Ultra3 SCSI controllers of FIG. 2 or a combination thereof. The processor 100 is also coupled to a CD-ROM drive 306 and the floppy drive 124 located off the system board 312.

The system board 312 may contain a ROM 314 and mechanical switches 304. Alternatively, the ROM 314 and mechanical switches 304 may be located on an option or expansion board 302 in the server. For example, the ROM 314 may be an option ROM of a video or SCSI controller in the server. The ROM 110 in FIGS. 1-2 or the ROM 314 contains server configuration profile images 300. These profile images 300, which may be stored in a reserved or protected area of Basic Input/Output System (BIOS) code, enable a single high-end server to adopt any of the corresponding server appliance personalities. The settings of the mechanical switches 304 (DIP (dual in-line package) or toggle switches, for example) determine which server appliance personality is adopted for the server. As an alternative to DIP switches, programmable logic with software-controlled settings may be employed. Either DIP switches or programmable logic can store server configuration identification information. Another alternative that can store the same is an option ROM or device.

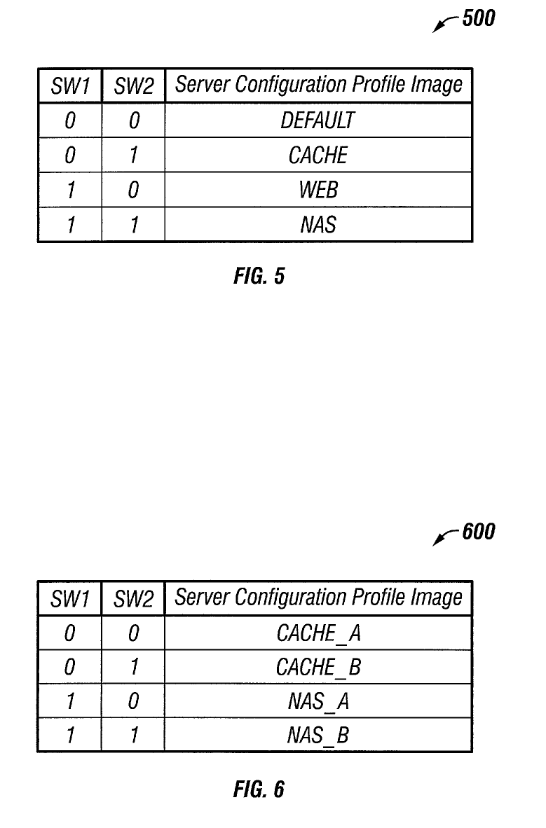

Turning to FIG. 5, an exemplary illustration of the use of switch settings is shown. For this example, the server configuration profile images 300 are DEFAULT, CACHE, WEB and NAS. CACHE, WEB and NAS represent highly optimized server configuration profile images. For example, CACHE may correspond to the C2500 and NAS may correspond to the N2400. If the switch settings (SW1, SW2) are “00,” then the DEFAULT server configuration profile image is pushed from the ROM 304 to the NVRAM 106. The DEFAULT server configuration profile image represents a minimal or base server configuration. Base or standard servers today typically include an on-board Ultra2 SCSI controller and possibly on-board NICs. If the switch settings are “01,” then the CACHE server configuration profile image is pushed from the ROM 304 to the NVRAM 106. If the switch settings are “10,” then the WEB server configuration profile image is pushed from the ROM 304 to the NVRAM 106. If the switch settings are “11,” then the NAS server configuration profile image is pushed from the ROM 304 to the NVRAM 106. It should be understood that “0” is synonymous with an off or open state of a switch and “1” is synonymous with an on or closed state of a switch.

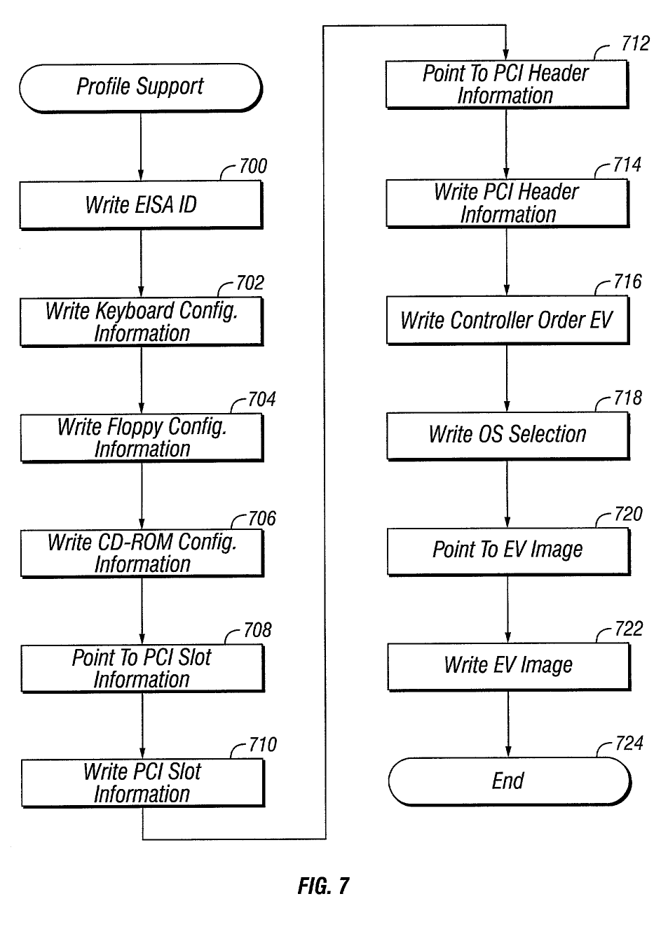

Turning to FIG. 6, an exemplary illustration of an alternative use of switch settings is shown. For this example, the highly optimized server configuration profile images 300 are CACHE_A, CACHE_B, NAS_A and NAS_B. If the switch settings are “00,” then the CACHE_A server configuration profile image is pushed from the ROM 304 to the NVRAM 106. If the switch settings are “01,” then the CACHE_B server configuration profile image is pushed from the ROM 304 to the NVRAM 106. If the switch settings are “10,” then the NAS_A server configuration profile image is pushed from the ROM 304 to the NVRAM 106. If the switch settings are “11,” then a NAS_B server configuration profile image is pushed from the ROM 304 to the NVRAM 106. CACHE_A and CACHE_B represent different server configuration profile images of a same general appliance server type—cache appliances. Similarly, NAS_A and NAS_B represent different server configuration profile images of a same general appliance server type—NAS appliances. It should be understood that the server configuration profile images represented in FIGS. 6 and 7 are illustrative and not exhaustive of the variety of server configuration profile images that might be employed. For example, in terms of FIG. 7, all four switch settings may alternatively represent four different cache server configuration profile images: CACHE_A, CACHE_B. CACHE_C and CACHE_D. It should further be understood that the representation of the switch settings as two bits is only exemplary.

Returning to FIG. 3, the system board 312 or option board 302 may be used in any appliance or server type represented by the settings of the mechanical switches 304. This approach eliminates the need for a different system board for each appliance type. Stated another way, an advantage of this approach is the capability to support multiple configuration profile images or personalities for a server with a single system or option board. Based on the switch settings and server configuration profile images represented in FIG. 5, the single system board 312 or option board 302 can be used for a standard server, cache appliance server or NAS appliance server. Based on the switch settings and server configuration profile images represented in FIG. 6, the single system board 312 or option board 302 can be used for two different types of cache appliance servers and two different types of NAS appliance servers.

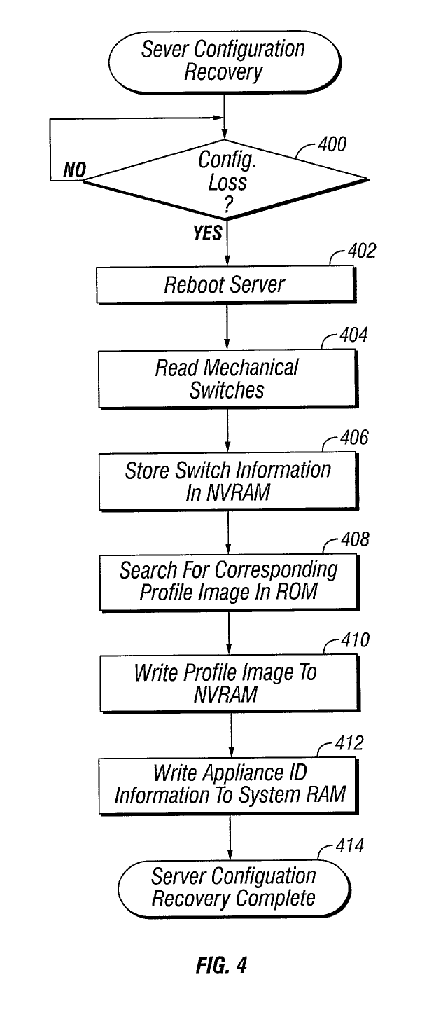

Referring to FIG. 4, an exemplary processor-executable server configuration process handled by code in the ROM 110 or 314 is shown. Beginning in step 400, it is determined if the server configuration profile image in the NVRAM 106 has been corrupted. This determination can be made by comparing the server configuration profile image in the NVRAM 106 with the server configuration profile image in the ROM 110 or 314. A server configuration profile image is created in the NVRAM 106 when the server is initially configured. If the profile image in the NVRAM 106 does not match the profile image in the ROM 314, then the profile image in the NVRAM 106 has been corrupted. An alternative way to check whether the NVRAM 106 is valid is to check the EISA ID or the controller order environmental variable in the NVRAM 106. A variety of predetermined states or conditions thus may be used to detect if the server configuration profile image in the NVRAM 106 is valid. If the server configuration profile image in the NVRAM 106 has not been corrupted, then the process remains in step 400.

If the server configuration profile image in the NVRAM 106 has been corrupted, then control proceeds to step 402 in which the server is rebooted or restarted. Next, in step 404, the process reads the settings or state information of the mechanical switches 304. This switch information is stored as an environmental variable in the NVRAM 106 in step 406. In step 408, the process searches for the server configuration profile image in the ROM 110 or 314 corresponding to the switch information. Following step 408, the located server configuration profile image is written or pushed to the NVRAM 106. This differs from conventional servers which typically resort to a base configuration profile image if an NVRAM error is detected. Next, in step 412, the appliance identification information corresponding to the profile image is written to the system information table (SIT) and system management BIOS (SMBIOS) tables of the system RAM 112. The appliance identification information may include the product model and name of the appliance. This is information which an application or driver of the server may read.

From step 412, the process completes in step 414. This process provides for automatic server configuration recovery of a highly optimized server configuration profile. If the configuration of the server is compromised, the configuration profile image is restored to the NVRAM 106 from the ROM 314. This avoids the need to reconfigure the server and reduces the downtime of the server. This technique is especially advantageous for servers deployed in a manner where it would be inconvenient to reconfigure them. One example would be a server at a site where no people are on site to manage the server. Another example would be a rack or density-optimized server which would require removing the server from the rack and plugging in the keyboard and monitor in order to reconfigure the server. Since the server configuration profile image is recovered without user intervention, this technique also avoids service calls to reconfigure the server. Though the servers represented in FIGS. 1-2 are appliance servers, it should be understood that this technique of automatic server configuration recovery may apply to any highly optimized server configuration profile image.

Referring to FIG. 7, an exemplary support process for a highly optimized server configuration profile image is shown. This process represents various steps that may be associated with pushing a highly optimized server configuration profile image from the ROM 314 or 110 to the NVRAM 106. Beginning in step 700, the EISA ID for the server configuration profile image is written to NVRAM 106. The EISA ID is a unique identifier for a server. For newer servers which do not have an EISA ID, an EISA ID is emulated as part of this process. An EISA ID is four bytes long. Next, in step 702, keyboard configuration information is written to NVRAM 106. In the case of a cache appliance server configuration profile image, the keyboard configuration information may indicate not to test the keyboard. The keyboard configuration information may also indicate not to display an F1 prompt when no keyboard is present. In step 704, floppy drive configuration information is written to NVRAM 106. Subsequently, in step 706, configuration information for the CD-ROM drive 306 is written to NVRAM 106.

In step 708, the process points to the PCI slot information of the particular profile image. The PCI slot information is then written to a PCI slot area of the NVRAM 106 in step 710. The PCI slot information includes the system board configuration information stored in slot zero. Next, in step 712, the process points to the PCI header information. The length of the PCI header is detected since the length may differ among server configurations profile images. The PCI header information is written to a PCI header area of the NVRAM 106 in step 714. PCI slot information and PCI header information generally differ for each server configuration profile image. Following step 714, the controller order environmental variable (EV) is written to the NVRAM 106. This variable generally indicates the boot order to be applied for the particular server configuration. For example, the variable may define the primary boot controller. In the case of a cache appliance server configuration profile image, this variable may indicate to disable the on-board SCSI controller and ROC controller and to not attempt to boot from the floppy drive. Similar information that may be written to the NVRAM 106 includes priority and rearrangement of SCSI controllers and NICs on different buses to optimize performance. For example, the controller order EV may specify that there should be one SCSI controller per bus and one NIC per bus. Controller priority may be based on the location of the operating system in the particular server.

Next, in step 718, an operating system (OS) selection variable is written to the NVRAM 106. This selection may identify the default operating system. The type of operating system selected may differ among the server configuration profile images. For example, while a Microsoft OS may be selected within a cache appliance server configuration profile image, a Novell OS may be selected within a NAS appliance server configuration profile image. In step 720, the process points to the EV image of the particular profile image. The length of the EV image is detected since the length may differ among server configuration profile images. In step 722, this EV image is written to an EV area of the NVRAM 106. Given the difference in format between the data in the NVRAM 106 and the BIOS code in the ROM 314, the EV image is written from bottom to top. Like the PCI slot image and PCI header image, the EV image generally differs for each server configuration profile image. As a form of verification, after each step of this process involving writing information, a checksum may be calculated.

The process of FIG. 7 can be implemented as common code containing multiple code branches or decisions. Such branching can be accomplished with the use of binary representations of the state information of the mechanical switches 304. These binary representations or masks may be used to identify the particular server configuration profile image based on the state information. For example, if a comparison operation on a mask for a NAS applicable server indicates that the server configuration is a NAS appliance server, then the mask triggers code branches to perform the steps of FIG. 7 with respect to the NAS appliance server configuration profile image. A separate mask may be defined for each server configuration profile image.

As compared to a first-generation or simple appliance server, a high-end appliance server such as the C2500 or the N2400, when configuration is lost or fails to work properly, presents a greater challenge for conventional BIOS self-healing techniques. A server configuration profile image for a high-end appliance server is highly complex as compared to a base configuration profile image of a first-generation appliance server. As apparent from the above description of FIG. 7, there are a number of complex issues relating to a server configuration profile image of a high-end appliance server. Each high-end appliance server varies in hardware configuration and system resource configuration. Hence, configuration recovery for a high-end appliance server is significantly more difficult than configuration recovery for a first generation appliance server. Additionally, a highly optimized configuration of a high-end server may be lost more easily than a configuration of a first-generation appliance server.

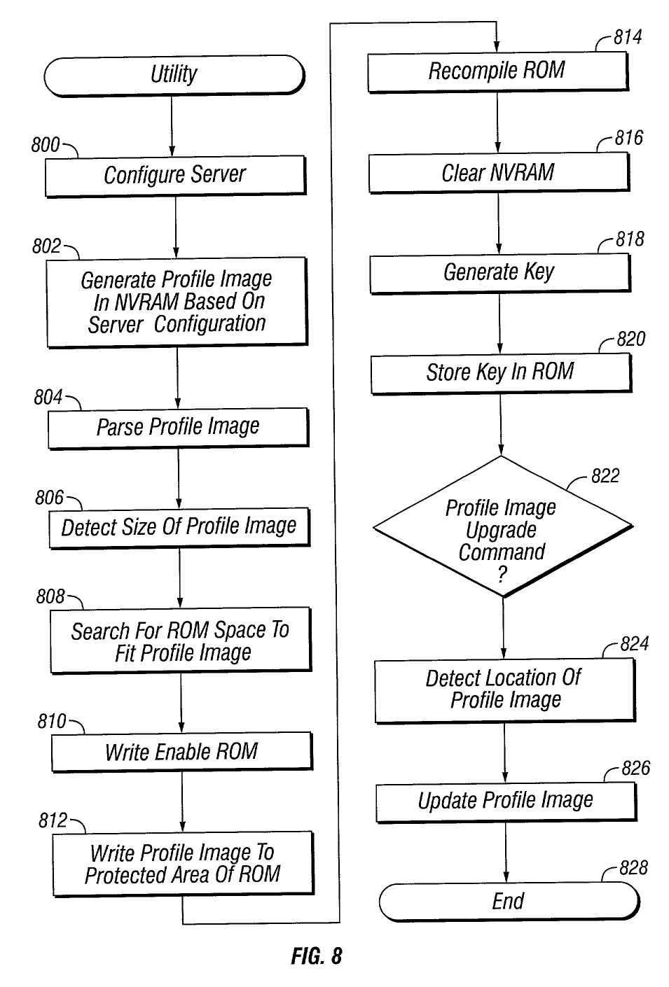

Referring to FIG. 8, an exemplary processor-executable utility process for dynamically generating a server configuration profile image is shown. The utility may for instance be part of a management tool. Beginning in step 800, the server is configured. Before this step, the devices intended for the configuration are placed in the server. The selection of devices may be customized based on a customer request. In step 802, the utility generates a profile in NVRAM based on the current server configuration. This step involves creating and saving an image in NVRAM based on the devices in the server. In other words, the utility creates a “snapshot” of the current highly optimized configuration of the server. Next, in step 802, the utility parses and reformats the profile to a format suitable for storage in the BIOS code of the ROM. This may involve reversing the order of the data in the NVRAM and placing a “db” in front of every sixteen bytes and an “h” after every two bytes. Alternatively, a normalizing function may be used to reformat the profile image.

In step 806, the size of the profile image is detected. The utility then searches for ROM space to fit the profile image in step 808. Next, in step 810, the ROM is write enabled or unlocked. In step 812, the profile image is written to a protected area of the ROM. The utility can create a protected area if one is not available. After this write, the switches in the server should be set to match the server configuration profile image. Following step 812, the ROM is recompiled in step 814. Next, in step 816, the NVRAM is cleared. In this way, when the server is booted up and detects a cleared NVRAM, the profile image in the ROM will be pushed to the NVRAM. In step 818, a key is generated for purposes of securely controlling future access to the profile image. In step 820, the key is stored in the ROM.

Steps 822-826 relate to an upgrade to the profile image. In step 822, the utility determines if a profile image upgrade command has been issued. If such a command is not detected, control remains in step 822. If the profile image upgrade command is detected, then the location of the profile image is detected in step 824. Similarly, a utility to flash the entire ROM should also be aware of the location of the profile image to avoid inadvertently overwriting the profile. In step 826, the profile image is updated. In this step, new information is written to the profile image. The process ends in step 828. If a device is added to a server, it may desirable to re-run the process.

The utility process of FIG. 8 differs from FIG. 3 in that multiple server configuration profile image need not be stored in ROM. Instead, the utility can be used to create a store a single server configuration profile image in the ROM. The utility process is dynamic in the sense that the profile image is created in the factory as part of the assembly process and the utility process accommodates a customer-requested or special order server configuration. The appliance configuration may be locked so that the server remains optimized for a single function. Alternatively, if a customer requests a configuration change for the server, the utility may reconfigure the server with a different server configuration profile image stored to ROM. The download of the new server configuration profile image to the server at the customer's site may be performed remotely over the Internet. The utility may use EISA IDs to distinguish different server configuration profile images since a different EISA ID is assigned to each appliance server configuration. This overall ability to dynamically pre-configure a system at the factory can be performed for appliance or non-appliance servers. Like the process of FIG. 4, the utility process of FIG. 8 avoids the need for reconfiguring a high-end server.

The foregoing disclosure and description of various embodiments are illustrative and explanatory thereof, and various changes in the server configurations, circuit boards, server appliance personality identification, writing techniques and components, as well as in the details of the illustrated circuitry and software and construction and method of operation may be made without departing from the spirit and scope of the invention.

I claim:

1. A server, comprising:
a processor;
a non-volatile random access memory coupled to the processor; and
a read only memory coupled to the processor, the read only memory comprising:
code containing a plurality of highly optimized server configuration profile images; and
processor executable configuration code to perform processor executable steps of:
detecting a predetermined state of the non-volatile random access memory;
rebooting the server in response to detecting the predetermined state of the non-volatile random access memory;
reading server configuration identification information following the reboot; and
writing a highly optimized server configuration profile image of the plurality of highly optimized server configuration profile images to the non-volatile random access memory based on the server configuration identification information.

2. The server of claim 1, wherein the plurality of highly optimized server configuration profile images comprises server configuration profile images of a different appliance server type.

3. The server of claim 1, wherein the server comprises a high-end server.

4. The server of claim 1, wherein the highly optimized server configuration profile image controls an arrangement of a plurality of Small Computer System Interface (SCSI) controllers on a bus of the server.

5. The server of claim 1, wherein the highly optimized server configuration profile image controls an arrangement of a plurality of network interface controllers on a bus of the server.

6. The server of claim 1, wherein the highly optimized server configuration profile image disables an on-board Small Computer System Interface (SCSI) controller of the server.

7. The server of claim 1, wherein the highly optimized server configuration profile image comprises a network attached storage server configuration profile image.

8. The server of claim 1, wherein the highly optimized server configuration profile image comprises a web server configuration profile image.

9. The server of claim 1, wherein the server configuration identification information comprises state information from a plurality of mechanical switches.

10. The server of claim 1, wherein the read only memory comprises an option read only memory.

11. The server of claim 1, wherein the read only memory comprises a system read only memory.

12. A read only memory program, comprising:
code containing a plurality of highly optimized server configuration profile images for a server; and
processor executable configuration code adapted to perform processor executable steps of:
detecting a predetermined state of a non-volatile random access memory of the server;
rebooting the server in response to detecting the predetermined state of the non-volatile random access memory;
reading server configuration identification information of the server following the reboot; and
writing a highly optimized server configuration profile image of the plurality of highly optimized server configuration profile images to the non-volatile random access memory based on the server configuration identification information.

13. The read only memory program of claim 12, wherein the server comprises a high-end server.

14. The read only memory program of claim 12, wherein the plurality of highly optimized server configuration profile images comprises server configuration profile images of a different appliance server type.

15. The read only memory program of claim 12, wherein the highly optimized server configuration profile image controls an arrangement of a plurality of network interface controllers on a bus of the server.

16. The read only memory program of claim 12, wherein the highly optimized server configuration profile image controls an arrangement of a plurality of Small Computer System Interface (SCSI) controllers on a bus of the server.

17. The read only memory program of claim 12, wherein the highly optimized server configuration profile image disables an on-board Small Computer System Interface (SCSI) controller of the server.

18. A utility, comprising:
processor executable configuration code to perform processor executable steps of:
generating a highly optimized server configuration profile image based on a current configuration of a server;
storing the highly optimized server configuration profile image in a non-volatile random access memory of the server;
parsing the highly optimized server configuration profile image; and
writing the highly optimized server configuration profile image to a read only memory of the server.

19. The utility of claim 18, the processor executable configuration code further performing the processor executable step of:
protecting the highly optimized server configuration profile image.

20. The utility of claim 18, the processor executable configuration code further performing the processor executable step of:
searching for space in the read only memory to fit the highly optimized server configuration profile image.

21. The utility of claim 18, wherein the highly optimized server configuration profile image comprises an appliance server configuration profile image.

22. The utility of claim 18, the processor executable configuration code further performing the processor executable step of:
updating the highly optimized server configuration profile image.

23. The utility of claim 18, the processor executable configuration code further performing the processor executable step of:
locating the highly optimized server configuration profile image.

24. The utility of claim 18, the processor executable configuration code further performing the processor executable step of:
configuring the server.

25. The utility of claim 18, wherein the server comprises a high-end server.
